(19) United States
(12) Patent Application Publication
(10) Pub. No.: US 2004/0184695 A1
(43) Pub. Date: Sep. 23, 2004

(54) Optical module

(76) Inventors: Cheng-Hsi Miao, San Jose, CA (US); Yeou-Yen Cheng, Saratoga, CA (US)

Correspondence Address: Billy Lau, 486 Vista Del Norte, Walnut, CA, 91789-1605, US

(21) Appl. No.: 10/391,688

(22) Filed: Mar. 18, 2003

(51) Int. Cl. G02B 6/00

(52) U.S. Cl. 385/11

(57) ABSTRACT

The present invention relates to an optical module that employs an integrated optical fiber collimator with a built-in polarizing beam splitter. According to an embodiment of the present invention, the integrated optical fiber collimator includes a collimator housing, an optical fiber, a collimating lens system that includes at least one lens, and a polarizing beam splitter. The optical fiber terminates in the collimator housing at an optical fiber termination. The collimating lens system is in the collimator housing and is in optically communication with the optical fiber through the optical fiber termination. The collimator housing mechanically supports the polarizing beam splitter. The polarizing beam splitter separates the light from the optical fiber into two substantially orthogonally polarized light beams and substantially couples two orthogonally polarized light beams to the optical fiber in conjunction with the collimating lens system.

### FIELD OF THE INVENTION

This invention generally relates to optical fiber technology. Particularly, this invention relates to an optical fiber module for optical fibers that employ an integrated fiber collimator. The integrated optical fiber collimator includes a polarizing beam splitter.

### BACKGROUND OF THE INVENTION

Optical fiber technology is widely applied in communications, including telecommunication, data communication, and cable television. A desirable feature of high performance optical fiber systems such as an optical fiber communication system is that all optical modules employed in the system be polarization insensitive. Optical performance and polarization insensitivity are competing goals. To achieve high performance, the optical modules in a high performance optical fiber system employ high performance optical materials. Unfortunately, many high performance optical materials are polarization sensitive. Techniques have been developed to construct polarization insensitive high performance optical modules with polarization sensitive high performance optical materials.

A popular technique to achieve polarization insensitivity in an optical module is to collimate the light entering the optical module through an optical fiber with an optical fiber collimator and then separate the collimated light beam into a first polarized light beam and a second polarized light beam with a polarizing beam splitter. The first and second polarized light beams are physically separated. The polarization of the first polarized light beam is orthogonal to the second polarized light beam. The polarization of either the first or the second polarized light beam is then rotated ninety degrees so that the first and second polarized light beams have substantially the same polarization state. The first and second polarized light beams then enter the polarization sensitive section of the optical module, which may include optical components made from polarization sensitive high performance optical materials. The polarization sensitive section of the optical module processes the first and second polarized light beams into first and second processed light beams respectively. When exiting the polarization sensitive section of the optical module, the polarization of either the first or the second processed light beam is rotated ninety degrees. After that, a second polarizing beam splitter combines the first and the second processed light beams into a single light beam. Then a second optical fiber collimator couples the single light beam to an optical fiber. One skilled in the art understands that the arrangement for processing the light from an optical fiber into two orthogonally polarized light beams with an optical fiber collimator and a polarizing beam splitter is identical to the arrangement for processing two orthogonally polarized light beams into a single light beam and couples the single light beam to an optical fiber with a polarizing beam splitter and an optical fiber collimator. The primary difference between the arrangements is the light propagation direction. One skilled in the art further understands that all physical optical components, including the optical fiber collimator, the collimating lens system, and the beam splitter, may only substantially perform their intended function and are unable to perform their intended function perfectly. Additionally, one skilled in the art may refer to the polarization state of a light beam as the polarization of the light beam. Because the first and second light beams have identical polarization when they pass through the polarization sensitive section of the optical module, the polarization sensitive section of the optical module processes them equally. Consequently, the optical module is polarization insensitive.

A commonly employed arrangement for collimating the light from an optical fiber and separating the collimated light beam into two orthogonally polarized light beams is shown in FIG. 1. The arrangement includes optical fiber collimator 103 and polarizing beam displacer 102 on baseplate 100. A polarizing beam displacer is a polarizing beam splitter that separates a light beam into two substantially orthogonally polarized parallel light beams that are physically separated. Referring to FIG. 1, an optical fiber collimator includes collimator housing 101, collimating lens 114, and the end portion of optical fiber 111. At the end of optical fiber 111 is optical fiber termination 113. Fiber ferrule 112 provides structural support to optical fiber 111. Collimator housing 101 holds fiber ferrule 112 and collimating lens 114. Collimating lens 114 collimates the light from optical fiber 111 through optical fiber termination 113 into a collimated light beam, which may have any polarization. Light path 120 of the collimated light beam is shown as the dot-dash line in FIG. 1. Beam displacer 102 separated the collimated light beam into a first and a second polarized light beam. Light path 121 and light path 122 are the light paths of the first polarized light beam and second polarized light beam respectively. The polarization of the first polarized light beam is substantially orthogonal to the polarization of the second polarized light beam. This arrangement can also be used to couple two orthogonally polarized light beams in an optical fiber. One skilled in the art understands that this arrangement has numerous applications besides the one stated above and there are numerous optical fiber collimator designs besides that shown in FIG. 1.

The above arrangement is commonly employed in optical modules. One of the steps in the fabrication process of the optical modules is to align the optical fiber collimator, the polarizing beam splitter, and other optical components in the optical modules. Aligning the optical fiber collimator, the polarizing beam splitter, and other optical components in the same step can be challenging because it involves aligning more than two optical components. It is desirable to integrate the polarizing beam splitter to the optical fiber collimator and align the two to form an integrated optical fiber collimator. By doing so, the number of optical components that require alignment in the fabrication of the optical module may be reduced and alignment process may be simplified. It is an object of this invention to provide an optical module that employs an integrated optical fiber collimator that includes a built-in polarizing beam splitter.

### SUMMARY OF THE INVENTION

According to this invention, an embodiment of the present invention includes an optical module that employs an integrated optical fiber collimator. The integrated optical fiber collimator includes a collimator housing, an optical fiber, a collimating lens system that includes at least one lens, and a polarizing beam splitter. The optical fiber terminates in the collimator housing at an optical fiber termination. The collimating lens system is in the collimator housing and is in optically communication with the optical fiber through the optical fiber termination. The collimator housing mechanically supports the polarizing beam splitter. The polarizing beam splitter separates the light from the optical fiber into two substantially orthogonally polarized light beams and substantially couples two orthogonally polarized light beams to the optical fiber in conjunction with the collimating lens system.

### DESCRIPTION OF THE DRAWINGS

A better understanding of the invention may be gained from the consideration of the following detailed description taken in conjunction with the accompanying drawings in which:

FIG. 1 shows the configuration of a common arrangement for collimating the light from an optical fiber and separating the collimated light beam into two orthogonally polarized light beams.

FIG. 2 shows the configuration of an integrated optical fiber collimator according to an embodiment of the present invention.

FIG. 3 shows the configuration of an integrated optical fiber collimator according to an alternative embodiment of the present invention.

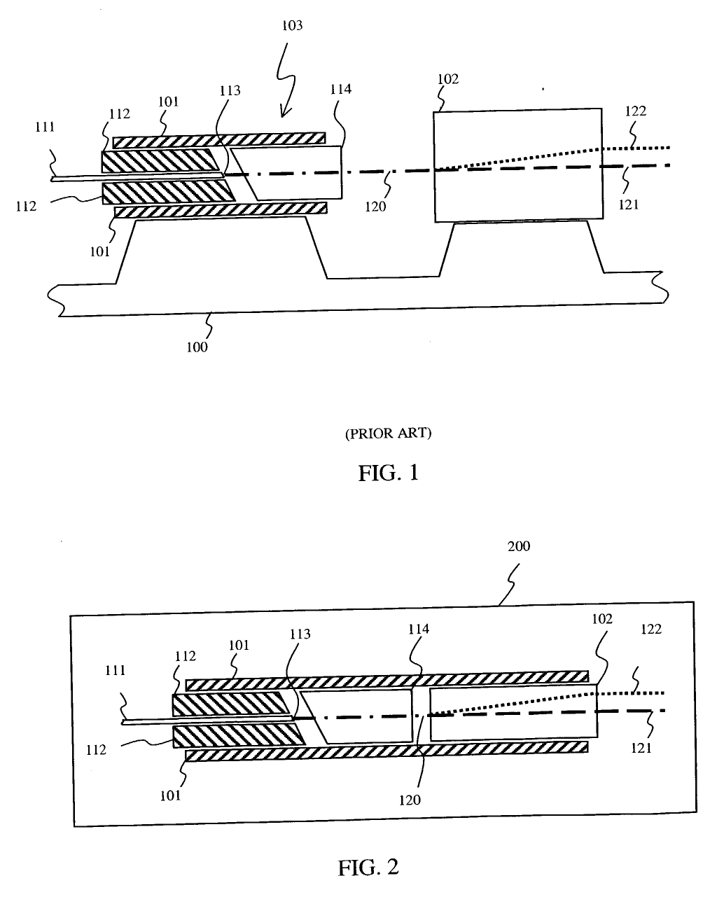

### DETAILED DESCRIPTION OF THE INVENTION

In the description that follows, like parts are indicated throughout the specification and drawings with the same reference numerals. The present invention is not limited to the specific embodiments illustrated herein.

Referring to FIG. 2, an embodiment according to this invention includes a module housing 200, one or more optical components and an integrated optical fiber collimator that optically couples one or more of the optical components in module housing 200 to an optical fiber. The integrated optical fiber collimator includes a polarizing beam splitter. The integrated optical fiber collimator either separates the light from the optical fiber into two orthogonally polarized light beams or couples two orthogonally polarized light beams to the optical fiber or both. FIG. 2 shows the configuration of an integrated optical fiber collimator according to an embodiment of the present invention. Referring to FIG. 2, an end portion of optical fiber 111 is inside fiber ferrule 112. At the end of optical fiber 111 is optical fiber termination 113. Optical fiber termination 113 and the surface of fiber ferrule 112 adjacent to optical fiber termination 113 are polished. One skilled in the art readily understands that the normal to the polished surfaces of optical fiber termination 113 and fiber ferrule 112 are typically at a small angle to the optical axis of optical fiber 111 at optical fiber termination 113. This small angle is optional and useful in reducing undesirable reflection. Collimating lens 114 collimates the light emitted from optical fiber 111 through optical fiber termination 113 into a collimated light beam. This collimated light beam may have any polarization. Light path 120 of the collimated light beam is shown as the dot-dash line in FIG. 2. In this embodiment, beam displacer 102 separated the collimated light beam into a first and a second polarized light beams. Light path 121 and light path 122 are the light paths of the first polarized light beam and the second polarized light beam respectively. The polarization of the first polarized light beam is orthogonal to the polarization of the second polarized light beam. As discussed above, two orthogonally polarized light beams can be coupled into optical fiber 111 with this embodiment.

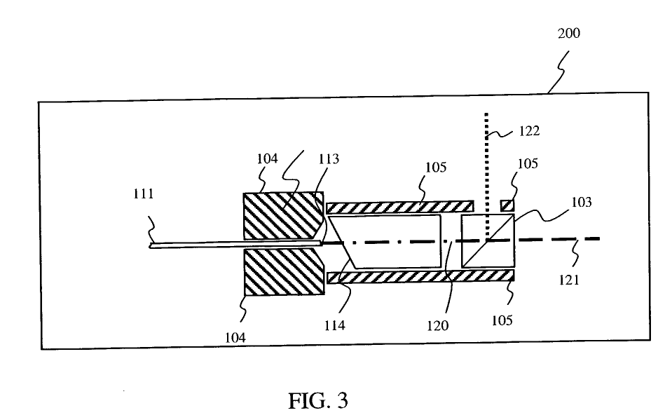

FIG. 3 shows the configuration of an alternative integrated optical fiber collimator according to an alternative embodiment of the present invention. In this embodiment, a cube polarizing beam splitter 103 is employed instead of a polarizing beam displacer and the fiber ferrule is eliminated. One skilled in the art understands that optical fiber termination 113 as configured is typically formed by cleaving optical fiber 111. Further, a multiple-piece collimator housing, which includes first collimator housing 104 and second collimator housing 105, is employed instead of a single-piece collimator housing. The offset between the optical axis of optical fiber 111 and the optical axis of collimating lens 114 may be adjusted during the alignment phase of the fabrication of this embodiment by adjusting the relative offset of first collimator housing 104 and second collimator housing 105.

There are numerous variations to the embodiments above trivial to one skilled in the art. Examples of these variations include but not limited to:

the single collimating lens 114 shown in the figures is replaced by a collimating lens system including at least one lens; and

the numerous types of polarizing beam splitters; representative examples include Glen-Laser Prism, Wollaston Prism, Beamsplitting Thompson Prism, polarizing beam displacer, and polarizing cube beam splitter.

Although the embodiment of the invention has been illustrated and that the form has been described, it is readily apparent to those skilled in the art that various modifications may be made therein without departing from the spirit of the invention.

What is claimed is:

1. An optical module, comprising:
a module housing;
an optical component in said module housing; and
an integrated optical fiber collimator;
wherein, said integrated optical fiber collimator, comprising:
a collimator housing in said module housing;
an optical fiber extending into said collimator housing having an optical fiber termination in said collimator housing;
a collimating lens system in said collimator housing being optically coupled to said optical fiber; and
a polarizing beam splitter being mechanically supported by said collimator housing and optically coupled to said optical fiber through said collimating lens system.

2. The optical module as claimed in claim 1, wherein, said collimating lens system comprises a lens.

3. The optical module as claimed in claim 1, wherein, said collimating lens system comprises a plurality of lenses.

4. The optical module as claimed in claim 1, wherein, said polarizing beam splitter comprises a polarizing beam displacer.

5. The optical module as claimed in claim 1, wherein, said polarizing beam splitter comprises a Glen-Laser Prism.

6. The optical module as claimed in claim 1, wherein, said polarizing beam splitter comprises a Wollaston Prism.

7. The optical module as claimed in claim 1, wherein, said polarizing beam splitter comprises a Beamsplitting Thompson Prism.

8. The optical module as claimed in claim 1, wherein, said polarizing beam splitter comprises a polarizing cube beam splitter.

9. The optical module as claimed in claim 1, further comprising:
a fiber ferrule in said collimator housing mechanically supporting a portion of said optical fiber.

10. The optical module as claimed in claim 1, wherein, said collimator housing comprises a single-piece collimator housing.

11. The optical module as claimed in claim 1, wherein, said collimator housing comprises a multi-piece collimator housing having at least two pieces.

12. The optical module as claimed in claim 11, wherein, said collimator housing, further comprising:
a first collimator housing; and
a second collimator housing.

13. The optical module as claimed in claim 12, wherein:
said end portion of said optical fiber is in said first collimator housing;
said collimating lens system is in said second collimator housing; and
said polarizing beam splitter is at least partially in said second collimator housing.

14. The optical module as claimed in claim 13, further comprising:
a fiber ferrule in said collimator housing mechanically supporting a portion of said optical fiber.

15. The optical module as claimed in claim 13, wherein, said polarizing beam splitter comprises a polarizing beam displacer.

16. The optical module as claimed in claim 13, wherein, said beam splitter comprises a cube beam splitter.

17. The optical module as claimed in claim 12, further comprising:
a fiber ferrule in said first collimator housing mechanically supporting a portion of said optical fiber.

18. The optical module as claimed in claim 17, wherein, said polarizing beam splitter comprises a polarizing beam displacer.

19. The optical module as claimed in claim 17, wherein, said beam splitter comprises a cube beam splitter.

20. The optical module as claimed in claim 2, wherein, said polarizing beam splitter comprises a polarizing beam displacer.

21. The optical module as claimed in claim 2, wherein, said beam splitter comprises a cube beam splitter.

22. An optical module, comprising:
a module housing means;
an optical component in said module housing; and
an integrated optical fiber collimator;
wherein, said integrated optical fiber collimator, comprising:
a collimator housing means in said module housing means;
an optical fiber extending into said collimator housing means having an optical fiber termination in said collimator housing means;
a collimating means in said collimator housing means for collimating the light traveling from said optical fiber through said optical fiber termination into a substantially collimated light beam and collecting light from the outside of said collimator housing means into said optical fiber; and
a polarizing means being mechanically supported by said housing means for separating said substantially collimated light beam into two collimated light beams of substantially mutually orthogonal polarizations and combining light of mutually orthogonal polarizations from the outside of said collimator housing.

23. The optical module as claimed in claim 22, wherein, said collimator housing means comprises a collimator housing.

24. The optical module as claimed in claim 22, wherein, said collimator housing means comprises a multi-piece collimator housing having at least two pieces.

25. The optical module as claimed in claim 24, wherein, said collimator housing means comprises:
a first collimator housing; and
a second collimator housing.

26. The optical module as claimed in claim 22, wherein, said collimating means comprises a collimating lens system.

27. The optical module as claimed in claim 26, wherein, said collimating lens system comprises at least one lens.

28. The optical module as claimed in claim 22, wherein, said polarizing means comprises a polarizing beam displacer.

29. The optical module as claimed in claim 22, wherein, said polarizing means comprises a Glen-Laser Prism.

30. The optical module as claimed in claim 22, wherein, said polarizing means comprises a Wollaston Prism.

31. The optical module as claimed in claim 22, wherein, said polarizing means comprises a Beamsplitting Thompson Prism.

32. The optical module as claimed in claim 22, wherein, said polarizing means comprises a polarizing cube beam splitter.

33. The optical module as claimed in claim 22, further comprising:
a fiber ferrule in said collimator housing mechanically supporting a portion of said optical fiber.

34. An optical module, comprising:
a module housing;
an optical component in said module housing; and
an integrated optical fiber collimator;
wherein, said integrated optical fiber collimator, comprising:
a collimator housing in said module housing having a first channel and a second channel, said first channel being coupled to said second channel;
an optical fiber having an optical fiber termination in said collimator housing, an end portion of said optical fiber being in said first channel;
a collimating lens system in said second channel being optically coupled to said optical fiber through said optical fiber termination; and
a polarizing beam splitter being at least partially in said collimator housing separating the light from said optical fiber into two substantially orthogonally polarized light beams and substantially coupling two orthogonally polarized light beams optically to said optical fiber in conjunction with said collimating lens system.

35. The optical module as claimed in claim 34, wherein, said collimator housing means comprises a multi-piece collimator housing having at least two pieces.

36. The optical module as claimed in claim 34, further comprising,
a fiber ferrule in said collimator housing mechanically supporting a portion of said optical fiber.

37. The optical module as claimed in claim 36, wherein, said collimating lens system comprises at least one lens.

38. The optical module as claimed in claim 34, wherein, said polarizing means comprises a polarizing beam displacer.

39. The optical module as claimed in claim 34, wherein, said polarizing means comprises a Glen-Laser Prism.

40. The optical module as claimed in claim 34, wherein, said polarizing means comprises a Wollaston Prism.

41. The optical module as claimed in claim 34, wherein, said polarizing means comprises a Beamsplitting Thompson Prism.

42. The optical module as claimed in claim 34, wherein, said polarizing means comprises a polarizing cube beam splitter.

43. An optical module, comprising:
a module housing;
an optical component in said module housing;
an optical fiber collimator having an collimator housing in said module housing; and
a polarizing beam splitter being mechanically supported by said collimator housing separating the light from said optical fiber collimator into two substantially orthogonally polarized light beams and substantially coupling two orthogonally polarized light beams optically to said optical fiber collimator.

44. The optical module as claimed in claim 43, wherein, at least a portion of said polarizing beam splitter is disposed in said collimator housing.

45. The optical module as claimed in claim 43, wherein, said polarizing beam splitter permanently attaches to said collimator housing.

46. The optical module as claimed in claim 43, wherein, said polarizing means comprises a polarizing beam displacer.

47. The optical module as claimed in claim 43, wherein, said polarizing means comprises a Glen-Laser Prism.

48. The optical module as claimed in claim 43, wherein, said polarizing means comprises a Wollaston Prism.

49. The optical module as claimed in claim 43, wherein, said polarizing means comprises a Beamsplitting Thompson Prism.

50. The optical module as claimed in claim 43, wherein, said polarizing means comprises a polarizing cube beam splitter.
